(19) United States
(12) Patent Application Publication
(10) Pub. No.: US 2025/0091136 A1
(43) Pub. Date: Mar. 20, 2025

(54) TOOL HOLDER WITH SEALED COOLANT TUBE AND KIT FOR A TOOL HOLDER

(71) Applicant: Franz Haimer Maschinenbau KG, Hollenbach-Igenhausen (DE)

(72) Inventor: Franz Haimer, Hollenbach-Igenhausen (DE)

(21) Appl. No.: 18/885,946

(22) Filed: Sep. 16, 2024

(30) Foreign Application Priority Data
Sep. 14, 2023 (DE) 10 2023 124 923.1

(51) Int. Cl. B23B 31/02

(52) U.S. Cl. CPC B23B 31/0261; B23B 2250/121

(57) ABSTRACT

A tool holder includes a receiving body, an interface at the rear for receiving the tool holder in a machine tool, a receiving section at the front for the tool, and a coolant bore arranged between the interface and the receiving section and by which coolant is conducted from the interface to the receiving section. The coolant bore has a first region with an adjoining second region. A coolant tube is arranged in the first region of the coolant bore. In the direction of the receiving section, between the coolant tube and the second region of the coolant bore, a cavity is formed in the receiving body or in the first region. A bridging element through which the coolant can flow and which seals the coolant flow in relation to the cavity is arranged in the cavity between the coolant tube and an interface-side end of the second region.

### CROSS-REFERENCE TO RELATED APPLICATION

This application claims the priority, under 35 U.S.C. § 119, of German Patent Application DE 10 2023 124 923.1, filed Sep. 14, 2023; the prior application is herewith incorporated by reference in its entirety.

### FIELD AND BACKGROUND OF THE INVENTION

The invention relates to a tool holder for the, in particular force-fitting, holding of a tool, in particular a rotary tool, and to a kit, in particular for such a tool holder.

FIG. 5 shows such a tool holder from the prior art.

The known tool holder illustrated in FIG. 5 is what is referred to as a PSC tool holder (in the form of a shrink-fit chuck), which—accordingly—provides a PSC interface (polygon shank taper, Capto, ISO 26623 spindle interface) at the rear or on the spindle-interface side at a receiving body of the holder—for receiving the PSC tool holder in a working spindle of a machine tool (or, for example, a tool turret for non-rotating machining).

Furthermore, as FIG. 5 shows, the receiving body of the PSC tool holder provides an axis of rotation, a receiving opening at the front or on the tool side on the receiving body—for the force-fitting holding of the rotary tool (the rotary tool is then shrunk into place here at the shrink-fit chuck)—and a coolant bore arranged along the axis of rotation between the PSC interface and the receiving opening. The coolant bore is used to conduct coolant along the axis of rotation from the PSC interface to the receiving opening.

As FIG. 5 furthermore also shows, the PSC tool holder—in the direction of the axis of rotation toward the receiving opening—provides a first region with an adjoining second region. A diameter of the first region is expanded in relation to a diameter of the second region.

In the case of the PSC tool holder, a coolant tube is screwed in the first region of expanded diameter of the coolant bore—in such a way that (if the coolant tube can be screwed only to a predetermined depth into the first region of expanded diameter of the coolant bore)—toward the receiving opening—between the coolant tube and the second region of smaller diameter of the coolant bore, a cavity forms in the receiving body or in the first region of expanded diameter.

A disadvantage of such a PSC tool holder or of such tool holders forming the cavity is that, if coolant is conducted through the tool holder, turbulence and bagging of the coolant in the cavity (“stowage space”) occurs, which may furthermore lead to reduced tool cooling.

### SUMMARY OF THE INVENTION

It is the object of the invention to improve the tool holders known in the prior art as described, in such a way that they enable improved cooling of tools.

This object is achieved by a tool holder and a kit having the features of the respective independent claim.

Advantageous developments of the invention are the subject matter of dependent claims and the description below—and refer to the tool holder and to the kit.

Any terms that are used, such as above, below, front, rear, left or right—unless explicitly defined otherwise—should be understood in the usual way—including with regard to the present figures. Terms such as radial and axial, where used and not explicitly defined otherwise, should be understood in relation to axes of rotation (or center axes, or axes of symmetry), of component parts/components described here—including with regard to the present figures.

The expression “substantially”—where used—may (in accordance with the understanding of the Supreme Court) be understood to mean “to a practically still significant degree”. Possible deviations from exactness that are thus implied by this concept may arise unintentionally (that is to say without any functional basis) owing to manufacturing or assembly tolerances or the like.

The tool holder for the, in particular force-fitting, holding of a tool, in particular a rotary tool, such as an end mill, provides a receiving body.

This receiving body has an axis of rotation, an interface at the rear for receiving the tool holder in a working spindle of a machine tool, and a receiving section at the front for the, in particular force-fitting, holding of the tool, in particular the rotary tool, and a coolant bore which is arranged along the axis of rotation between the interface and the receiving section.

By means of the coolant bore, coolant can be or is conducted along the axis of rotation from the interface to the receiving section. The coolant may be gaseous and/or liquid fluids such as air, CO₂, N₂ or gas-liquid mixtures (oil mist) as are used for minimum quantity lubrication.

This coolant bore furthermore also provides—in the direction of the axis of rotation toward the receiving section—a first region with an adjoining second region, wherein a diameter of the first region is expanded in relation to a diameter of the second region. In short and clearly, the first region is larger in diameter than the second region.

Also, the receiving body has a coolant tube which is arranged in the first region of expanded diameter of the coolant bore and by means of which coolant is conducted in an interior or through the interior of the receiving body, more precisely in or through the second region of larger diameter.

In the direction of the receiving section—between the coolant tube and the second region of smaller diameter of the coolant bore—a cavity is formed in the receiving body or in the first region of expanded diameter.

This cavity is formed in particular because or whenever the coolant tube can only be inserted, in particular screwed, to a limited depth into the first region of expanded diameter. In other words, the coolant tube cannot be inserted, in particular screwed, here into the first region of expanded diameter as far as the interface-side end of the second region of smaller diameter.

The tool holder is distinguished in that a bridging element through which coolant can flow and which seals the coolant flow in relation to the cavity is arranged in the cavity between the coolant tube and an interface-side end of the second region of smaller diameter.

Expressed in simplified and clear terms, the tool holder makes provision to bridge the cavity with an intermediate piece—between the coolant tube and the second region—i.e., with the bridging element (which is sealed in relation to the cavity).

This, which proves to be particularly advantageous, can prevent coolant from being able to flow from the coolant tube into the cavity.

The invention is based on the consideration that up to now a coolant flowing from the coolant tube into the cavity and flowing through said cavity causes turbulence and bagging in the cavity.

Not least for this reason, the inner diameter of the coolant tube arranged in the first region of expanded diameter is—inevitably—smaller than the diameter of the cavity itself (i.e., of the first region of expanded diameter).

If the coolant thus flows (virtually seamlessly) from a region of smaller diameter into a region of larger diameter, (in clear and simplified terms) the coolant flow or the coolant “deviates” into the lateral, expanded regions of the cavity—and bagging and turbulence may occur (there).

In particular even in the case of what is referred to as minimum quantity lubrication—by means of an oil mist or an air-oil mixture—the oil of the mixture is pressed—due to weight and rotation—into the lateral regions of the cavity (where it can accumulate). The coolant flow is disturbed; the composition of the further flow of coolant mixture is changed.

However, if the tool holder now makes provision that a bridging element through which coolant can flow and which seals the coolant flow in relation to the cavity is arranged in the cavity between the coolant tube and an interface-side end of the second region of smaller diameter, the tool holder achieves the effect that the coolant flow is stabilized or remains constant, and the coolant no longer flows through the cavity itself, but rather through the bridging element located there (—and thus the coolant flow can simply no longer “deviate” into the expanded regions of the first region of expanded diameter or of the cavity). This allows the coolant to flow to the receiving section—and thus to the tool—without turbulence and without bagging.

Preferably—and in particular even in the case of force-fitting holding, it may be provided that the receiving section is a receiving opening in which the tool, in particular, or, for example, an end mill, can be pushed in/held—in particular in a force-fitting manner. In such a case, the tool holder could be a clamping chuck, for example a shrink-fit chuck, a hydraulic expansion chuck or a collet chuck.

Alternatively, the receiving section could also be a (receiving) pin or similar, on which the tool is held.

The tool could be a rotary tool or a turning tool.

Provision may also be made that—in order to compensate for different axial lengths of the cavity to be bridged—of coolant tube and second region of smaller diameter—the bridging element in each case has an individual length adapted to the cavity.

Preferably, provision may be made that an inner bore of the bridging element has a substantially identical diameter to a diameter of an inner bore of the coolant tube and/or to a diameter of the second region of smaller diameter of the coolant bore.

Provision may also be made that an inner bore of the bridging element has a diameter that changes, in particular continuously, along the axis of rotation from the interface toward the receiving section, wherein in particular the diameter of the inner bore of the bridging element at its receiving-section end is substantially identical to a diameter of the second region of smaller diameter of the coolant bore.

If, namely, the inner bore of the coolant tube and the diameter of the second region of smaller diameter differ, the inner bore of the bridging element can thus adjust this difference in diameter—in particular continuously.

Provision may also be made that the bridging element is substantially hollow-cylindrical—with a front-side or receiving-section-side sealing flange, which lies sealingly against the rear-side or interface-side end of the second region of smaller diameter.

Furthermore, it may be expedient if the coolant tube is arranged screwed in the first region of expanded diameter of the coolant bore, in particular is arranged screwed to a predeterminable maximum screw-in depth in the first region of expanded diameter of the coolant bore.

The—limited—screw-in depth can result, for example, from a stop, a shoulder or the like or even from a thread length alone or when using a screw-in aid.

According to a preferred embodiment, provision may also be made that the coolant tube is configured in multiple parts with at least one feed tube, a threaded bushing, in particular with an external thread, and a flange element.

It may also be expedient if the bridging element is held screwed or pressed to the flange element of the coolant tube.

It also appears expedient if the coolant tube is screwed by means of its threaded bushing in the interior of the receiving body or in the first region of expanded diameter of the coolant bore.

It is also preferred if the flange element is held screwed or pressed in an inner bore of the threaded bushing.

In a preferred embodiment, provision is then made that the bridging element is made of plastic or rubber or an elastomer—or is elastic in some other way. The bridging element may also be spring-loaded, for example a spring-loaded tube.

Furthermore, the coolant may be gaseous and/or liquid fluids such as air, CO₂, N₂ or gas-liquid mixtures (oil mist).

It also appears expedient if sealing elements are arranged on the coolant tube and/or on the feed tube, the sealing elements sealing the coolant tube and/or feed tube in relation to the first region of expanded diameter, or the threaded bushing and/or the flange element.

It is preferred if the interface is a PSC interface or an ISO 26623 spindle interface or a KM4X interface.

Furthermore, it also appears expedient if the invention provides a kit, in particular for the tool holder.

The kit is intended to have the or a coolant tube, in particular for the tool holder, and a plurality of bridging elements, in particular for the tool holder, with the internal bores or internal bores of the respective bridging elements each differing in diameter and/or differing in length.

Provision may furthermore also be made here that the inner bores of the bridging elements have a diameter that changes, in particular continuously, along the axis of rotation from the interface toward the receiving section, wherein in particular the diameter of the inner bore of the respective bridging element at its receiving-section end is substantially identical to a diameter of the second region of smaller diameter of the coolant bore.

The plurality of bridging elements would then be exchangeable—and, if they provide different, in particular even changing, inner bore diameters, could compensate for different differences in diameter—of coolant tube and second region of smaller diameter.

The plurality of bridging elements would then also be exchangeable—and, if they provide various lengths, could compensate for different axial lengths of the cavity to be bridged—of coolant tube and second region of smaller diameter.

Finally, it can be stated with regard to the invention that it is distinguished by all of its aspects, in particular by simplicity, efficiency and effectiveness—and contributes significantly to an improved coolant flow and tool cooling.

The description given so far of advantageous embodiments of the invention includes numerous features that are reproduced in the individual dependent claims, in some cases together. However, these features may expediently also be considered individually and combined into appropriate further combinations.

Even though some terms are used in each case in the singular or in combination with a numeral in the description and/or in the patent claims, the scope of the invention is not intended to be limited to the singular or the respective numeral for these terms. Furthermore, the words “a” or “an” should not be understood as numerals, but as indefinite articles.

The properties, features and advantages of the invention that are described above and the manner in which they are achieved will become clearer and more clearly understandable in conjunction with the following description of the exemplary embodiments of the invention, which are explained in greater detail in conjunction with the drawing(s)/figure(s) (identical components/component parts and functions have the same reference signs in the drawings/figures).

The exemplary embodiments are used to explain the invention and do not restrict the invention to the combinations of features, including with respect to functional features, that are specified therein. For this purpose, it is moreover also possible for suitable features of each exemplary embodiment to be considered explicitly in isolation, removed from one exemplary embodiment, introduced into another exemplary embodiment in order to supplement the latter and combined with any one of the claims.

Other features which are considered as characteristic for the invention are set forth in the appended claims.

Although the invention is illustrated and described herein as embodied in a tool holder with a sealed coolant tube, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, sectional view of a PSC shrink-fit chuck with an inner feedthrough of cooling lubricant through a tool according to one embodiment of the invention;

FIG. 2 is a sectional view of the PSC shrink-fit chuck according to FIG. 1 in a further view;

FIG. 3 is a sectional view showing the PSC shrink-fit chuck according to FIG. 2 in a further view;

FIG. 4 is a sectional view showing the PSC shrink-fit chuck according to FIG. 2 in a further view; and

FIG. 5 is a sectional view of a PSC or Capto tool holder or shrink-fit chuck from the prior art.

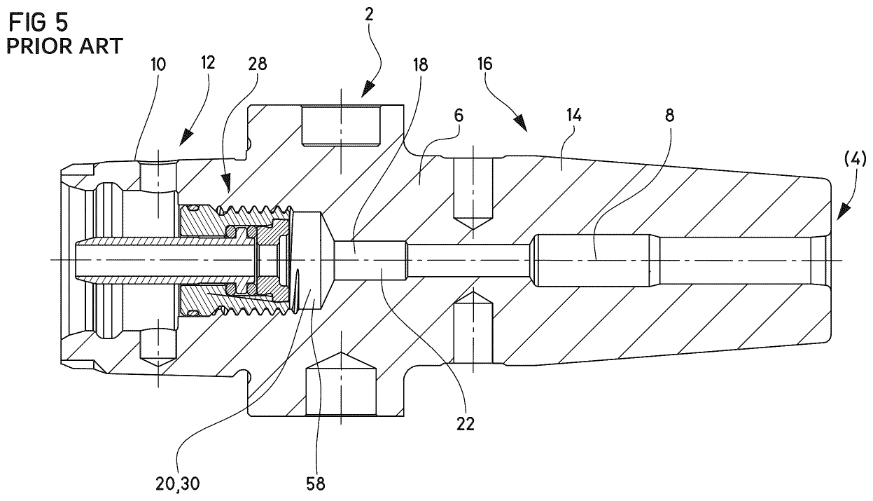

### DETAILED DESCRIPTION OF THE INVENTION

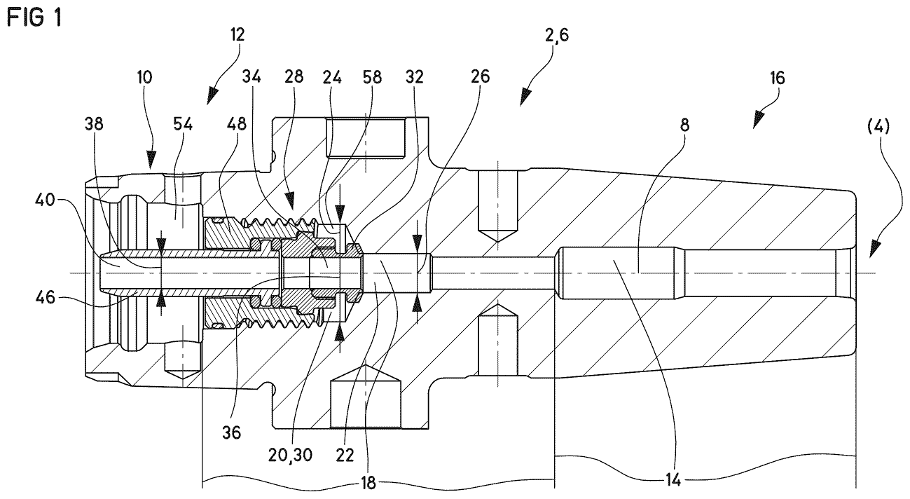

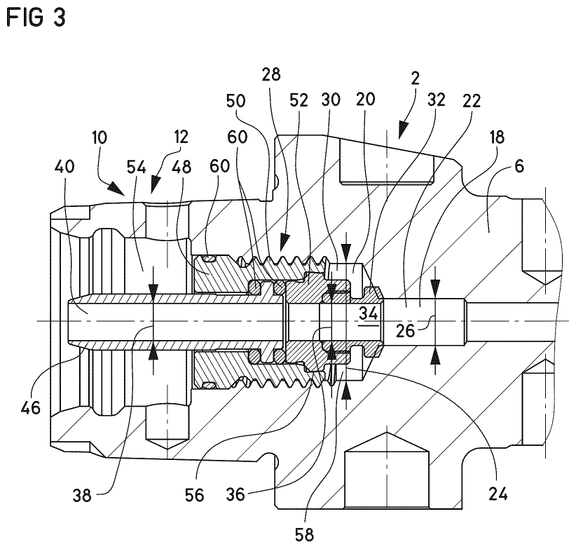

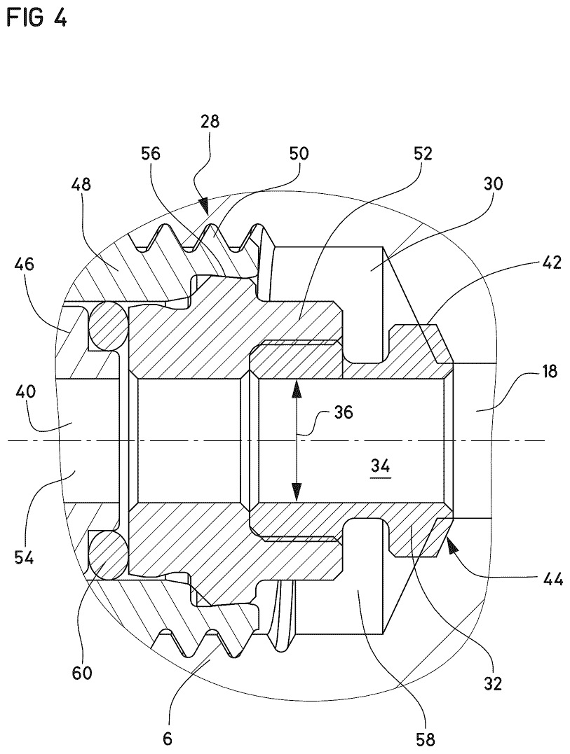

Referring now to the figures of the drawings in detail and first, particularly to FIGS. 1-4 thereof, there is shown a PSC shrink-fit chuck 2 with improved inner feedthrough of cooling lubricant through the tool.

FIGS. 1 to 4 show—in various views and details—a tool holder 2, in this case a PSC tool holder 2 in the form of the shrink-fit chuck 2, i.e., a shrink-fit chuck 2, which provides a PSC interface 10,—with improved inner feedthrough of cooling lubricant through the tool holder.

That is to say, the tool holder 2 shown in FIGS. 1 to 4 (the tool holder is also referred to merely as “holder” 2 for short below) is what is referred to as a PSC shrink-fit chuck 2, which—accordingly—provides a PSC interface 2 (cf. ISO 26623 spindle interface) at a rear 12 in a receiving body 6 of the PSC shrink-fit chuck 2 for receiving the PSC shrink-fit chuck 2 in a working spindle (or—when machining is stationary—for example, in a tool turret (not shown) of a machine tool (not shown)).

The holder 2 shown in FIGS. 1 to 4 is distinguished by an improved inner feedthrough of cooling lubricant through the tool/holder 2, which will be discussed in more detail later.

Furthermore, as shown in FIGS. 1 to 4, the receiving body 6 of the holder provides an axis of rotation 8 and a receiving opening 14 at a front 16 on the receiving body 6—for the force-fitting holding of the rotary tool 4 (the rotary tool 4, for example an end mill, is then shrunk into place here at the shrink-fit chuck 2) (not shown).

For the discussed inner feedthrough of cooling lubricant, the holder 2 realizes a coolant bore 18 arranged along the axis of rotation 8 between the PSC interface 10 and the receiving opening 14. The coolant bore 18 is used to conduct coolant or the cooling lubricant along the axis of rotation 8 from the PSC interface 10 to the receiving opening 14.

The coolant bore 18 in or in an interior 54 of the holder 2 or the receiving body 6 has various regions—toward the receiving opening 14 in the direction of the axis of rotation 8, namely a first region 20 with an adjoining second region 22. As shown in FIGS. 1 to 4, a diameter 24 of the first region 20 is expanded in relation to a diameter 26 of the second region 22.

An—in this case—multi-part coolant tube 28—consisting of a feed tube 46, a threaded bushing 48—having an external thread 50—and a flange element 52 is arranged in the first region 20 of expanded diameter 24 of the coolant bore 18.

As shown in FIGS. 1 to 4 here, the coolant tube 28 is screwed—above the flange element—by means of its threaded bushing 48, which has the external thread 50, in the interior 54 of the receiving body 6/holder 2 or in the first region 20 of expanded diameter 24 of the coolant bore 18.

The flange element 52 is held pressed in an inner bore 56 of the threaded bushing 48—on the receiving-opening side. The feed tube is held sealed in the inner bore 56 of the threaded bushing—on the interface side of the threaded bushing 48. This holding also allows small angular errors/deviations in the feed tube 46 to be compensated for.

If, as can also be gathered from FIGS. 1 to 4, the coolant tube 28 is or can be screwed only to a predetermined depth into the first region 20 of expanded diameter 24 of the coolant bore 18, a cavity 30 thus forms in the receiving body 6 or in the first region 20 of expanded diameter 24—in the direction of the receiving opening 14—between the coolant tube 28 and the second region 26 of smaller diameter 26 of the coolant bore 18.

For the discussed—improved—inner feedthrough of cooling lubricant, the holder 2 realizes a bridging element 32 through which coolant or the cooling lubricant can flow and which seals the coolant flow in relation to the cavity 30 in the cavity 30 between the coolant tube 28 and the interface-side end 44 of the second region 22 of smaller diameter 26.

This bridging element 32, which is substantially hollow-cylindrical and is an elastomer and provides a front-side/receiving-opening-side sealing flange 42—lies, as FIGS. 1 to 4 illustrate,—sealingly by means of the elastically deformable sealing flange 42—against the interface-side end 44 of the second region 22 of smaller diameter 26.

On the interface side—the bridging element 32 is held pressed in the flange element 52 of the coolant tube 28.

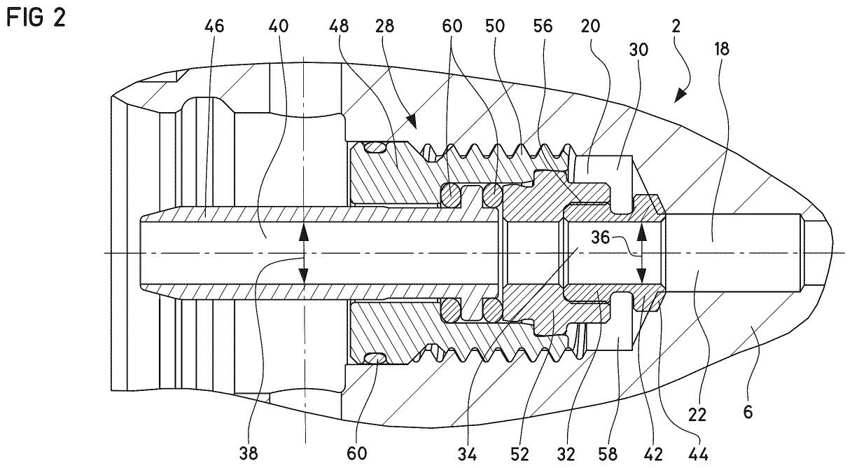

As can be gathered from FIGS. 2 to 4, the inner bore 34 of the bridging element 32 provides a substantially identical diameter 36 to the diameter 38 of the inner bore 40 of the coolant tube 28 or its feed tube 46, and to the diameter 26 of the second region 22 of smaller diameter 26 of the coolant bore 18.

This means that the coolant or cooling lubricant is fed in the interior 54 of the holder 2/receiving body 6 or in the coolant bore 18 in the interior 54 of the holder 2/receiving body 6—along the axis of rotation 8 through the holder 2 (on the interface side toward the receiving-opening side)—with an approximately constant identical (flow) cross section.

The coolant guide or the coolant tube 28 and the bridging element 32 are furthermore also sealed in relation to the cavity 30 by further sealing means 60, such as sealing elements 60, here in particular sealing rings 60, at the coolant tube 28, i.e., at the threaded bushing 48, at the flange element 52, and at the feed tube 46 of the coolant tube 28.

The discussed—improved—inner feedthrough of cooling lubricant is simplified and clearly described/expressed: the holder 2 makes provision to bridge the cavity 30 between the coolant tube 28 and the second region 22 of smaller diameter 26 with an intermediate piece 32—between the coolant tube 28 and the second region 22 of smaller diameter 26, i.e., using the bridging element 32 (which is sealed in relation to the cavity 30)—in a coolant-tight manner and with a flow cross section kept constant.

It can thereby be avoided that coolant or the cooling lubricant can flow from the coolant tube 28 into the cavity 30 or there into the expanded regions 58 of the cavity 30 or the first region 20 of expanded diameter 24, and the effect can be achieved that the coolant flow is stabilized or remains constant, and the coolant flows through the coolant feed virtually with a constant cross section—because of the bridging element 32 now used. This allows the coolant to be conducted or to flow to the receiving section—and thus to the tool—without turbulence and without bagging.

Although the invention has been illustrated and described in more detail by the preferred exemplary embodiments, the invention is not restricted by the examples disclosed and other variations can be derived therefrom, without departing from the scope of protection of the invention.

The following is a summary list of reference numerals, and the corresponding structure used in the above description of the invention:
2 tool holder, shrink-fit chuck
4 tool, rotary tool, turning tool
6 receiving body
8 axis of rotation
10 interface
12 at the rear
14 receiving section, receiving opening
16 at the front
18 coolant bore
20 first region
22 second region
24 diameter of the first region (20)
26 diameter of the second region (22)
28 (multi-part) coolant tube
30 cavity
32 (sealing) bridging element
34 inner bore of the bridging element (32)
36 diameter of the inner bore (34)
38 diameter of the inner bore (40)
40 inner bore of the coolant tube (28) or of the feed tube (46)
42 sealing flange of the (sealing) bridging element (32)
44 interface-side end of the second region (22) of smaller diameter (26)
46 feed tube of the (multi-part) coolant tube (28)
48 threaded bushing of the (multi-part) coolant tube (28)
50 external thread of threaded bushing (48)
52 flange element of the (multi-part) coolant tube (28)
54 interior of the receiving body or of the tool holder
56 inner bore of the threaded bushing (48)
58 extended regions of the first region (20) of expanded diameter (24) or of the cavity (30)
60 sealing element/ring

1. A tool holder for holding of a tool, the tool holder comprising:
a receiving body having an axis of rotation, said receiving body further containing:
an interface, at a rear of said receiving body, for engaging the tool holder in a working spindle of a machine tool;
a receiving section, at a front of said receiving body, for the holding of the tool; and
a coolant bore disposed along the axis of rotation between said interface and said receiving section and by means of said coolant bore coolant is conducted along the axis of rotation from said interface to said receiving section and said coolant bore, in a direction of the axis of rotation toward said receiving section, having a first region with an adjoining second region having an interface-side end, wherein a diameter of said first region is expanded in relation to a diameter of said second region;
a coolant tube disposed in said first region of expanded diameter of said coolant bore;
said receiving body or said first region of expanded diameter having a cavity formed therein in a direction of said receiving section, between said coolant tube and said second region of smaller diameter of said coolant bore; and
a bridging element, through which coolant can flow and which seals a coolant flow in relation to said cavity, is disposed in said cavity between said coolant tube and said interface-side end of said second region of smaller diameter.

2. The tool holder according to claim 1, wherein:
said coolant tube has an inner bore; and
said bridging element has an inner bore, said inner bore of said bridging element has a substantially identical diameter to a diameter of said inner bore of said coolant tube and/or to a diameter of said second region of smaller diameter of said coolant bore.

3. The tool holder according to claim 1, wherein said bridging element has an inner bore with a diameter that changes along the axis of rotation from said interface toward said receiving section.

4. The tool holder according to claim 1, wherein said bridging element is a substantially hollow-cylindrical with a front-side sealing flange, which lies sealingly against said interface-side end of said second region of smaller diameter.

5. The tool holder according to claim 1, wherein said coolant tube is disposed screwed in said first region of expanded diameter of said coolant bore.

6. The tool holder according to claim 1, wherein said coolant tube is configured in multiple parts with at least one feed tube, a threaded bushing, and a flange element.

7. The tool holder according to claim 1, wherein said coolant tube has a flange element, said bridging element is held screwed or pressed to said flange element of said coolant tube.

8. The tool holder according to claim 1, wherein said coolant tube has a threaded bushing, said coolant tube is screwed by means of said threaded bushing in an interior of said receiving body or in said first region of expanded diameter of said coolant bore.

9. The tool holder according to claim 8, wherein said coolant tube has a flange element, said flange element is held screwed or pressed in an inner bore of said threaded bushing.

10. The tool holder according to claim 1, wherein said bridging element is made of plastic or rubber or an elastomer or is elastic in some other way or is a spring-loaded tube.

11. The tool holder according to claim 1, wherein said receiving section is a receiving opening for the holding of the tool.

12. The tool holder according to claim 6, further comprising sealing elements disposed on said coolant tube and/or on said at least one feed tube, said sealing elements sealing said coolant tube and/or said at least one feed tube in relation to said first region of expanded diameter, or said threaded bushing and/or said flange element.

13. The tool holder according to claim 1, wherein said interface is a private service connect interface or an ISO 26623 spindle interface or a KM4X interface.

14. The tool holder according to claim 1, wherein said receiving section holds the tool in a force-fitting manner and the tool is a rotary tool.

15. The tool holder according to claim 3, wherein:
said inner bore of said bridging element changes diameter continuously along the axis of rotation from said interface toward said receiving section; and
said bridging element has a receiving-section end, the diameter of said inner bore of said bridging element at said receiving-section end is substantially identical to a diameter of said second region of smaller diameter of said coolant bore.

16. The tool holder according to claim 1, wherein said coolant tube is disposed screwed in said first region of expanded diameter of said coolant bore, namely said coolant tube is screwed to a predeterminable maximum screw-in depth in said first region of expanded diameter of said coolant bore.

17. The tool holder according to claim 6, wherein said threaded bushing has an external thread.

18. The tool holder according to claim 1, wherein:
said receiving section is a receiving opening for a force-fitting holding of the tool being a rotary tool; and/or
the tool is a rotary tool or a turning tool; and/or
the rotary tool is an end mill.

19. A kit for a tool holder, the kit comprising:
a coolant tube for the tool holder; and
a plurality of bridging elements for the tool holder, said bridge elements having internal bores each differing in diameter and/or differing in length.
